(19) United States
(12) Patent Application Publication
(10) Pub. No.: US 2020/0213717 A1
(43) Pub. Date: Jul. 2, 2020

(54) LOUDSPEAKER DEVICE

(71) Applicant: ZORZO CO., LTD., Tokyo (JP)

(72) Inventor: Teppei YAMADA, Tokyo (JP)

(21) Appl. No.: 16/726,451

(22) Filed: Dec. 24, 2019

(30) Foreign Application Priority Data
Dec. 26, 2018 (JP) 2018-242529

(51) Int. Cl. H04R 1/28; H04R 1/02; H04R 7/12

(52) U.S. Cl. CPC H04R 1/2811; H04R 2400/11; H04R 7/12; H04R 1/025

(57) ABSTRACT

Even-numbered loudspeaker units 12b, 12d, 12f and 12h face substantially opposite directions with respect to preceding ones 12a, 12c, 12e and 12g of the loudspeaker units, respectively, and are disposed so that frame bodies thereof are adjacent to the frame bodies of the preceding loudspeaker units 12a, 12c, 12e and 12g, respectively. Odd-numbered loudspeaker units 12c, 12e and 12g face substantially opposite directions with respect to the preceding ones 12b, 12d and 12f of the loudspeaker units, respectively, and are disposed so that at least portions of diaphragms thereof closely oppose at least portions of the diaphragms of the preceding loudspeaker units 12b, 12d and 12f.

### TECHNICAL FIELD

The present invention is related to a loudspeaker device.

### BACKGROUND ART

JP2018-182387A discloses a loudspeaker device where a plurality of loudspeaker units are combined to keep a volume of a sealed space constant. This enables to cancel back pressures of diaphragms and thereby to improve bass characteristics.

### SUMMARY OF INVENTION

### Technical Problem

In order to further improve the bass characteristics of the loudspeaker device, it is necessary to promptly eliminate unevenness of a pressure generated in the sealed space by the movement of the diaphragm. For this purpose, it is important to make the distance between the diaphragms as short as possible and to make the volume of the sealed space as small as possible. However, in a commercially available loudspeaker unit, the driver unit and/or the frame body are disposed on a rear side of the diaphragm. This makes it difficult to shorten the distance between the diaphragm or to reduce the volume of the sealed space.

The present invention aims to use commercially available loudspeaker units and simultaneously to make the distance between the diaphragms as short as possible and to make the volume of the sealed space as small as possible, and thereby to further improve the bass characteristics of the loudspeaker device.

### Solution to Problem

A loudspeaker device includes a 2n number (n is a natural number of 2 or larger.) of loudspeaker units, a n number of first space defining sections, and a (n−1) number of second space defining section. Each of the loudspeaker units is generally conical in shape as a whole, and has a diaphragm, a driver unit disposed on a rear side of the diaphragm for inputting an electrical signal to drive the diaphragm, and a frame body supporting the diaphragm and the driver unit. A 2i^{th} loudspeaker unit (i is a natural number of n or smaller.) of the loudspeaker units is disposed so as to face a substantially opposite direction with respect to a (2i−1)^{th} one of the loudspeaker units, and so that the frame body thereof is adjacent to the frame body of the (2i−1)^{th} loudspeaker unit. A i^{th} one of the first space defining sections makes a space surrounded by the diaphragm and the frame body of the (2i−1)^{th} loudspeaker unit and a space surrounded by the diaphragm and the frame body of the 2i^{th} loudspeaker unit communicating and being sealed, to define a first space. A (2j+1)^{th} loudspeaker unit (j is a natural number of (n−1) or smaller.) of the loudspeaker units is disposed so as to face a substantially opposite direction with respect to a 2j^{th} one of the loudspeaker units, and so that at least a portion of the diaphragm closely opposes at least a portion of the diaphragm of the 2j^{th} loudspeaker unit. A j^{th} one of the second space defining section seals a space surrounded by the diaphragm of the 2j^{th} loudspeaker unit and the diaphragm of the (2j+1)^{th} loudspeaker unit to define a second space.

The 2i^{th} loudspeaker unit may be disposed in substantially the same direction as a predetermined direction, with respect to the (2i−1)^{th} loudspeaker unit. The (2j+1)^{th} loudspeaker unit may be disposed at a position shifted in substantially the same direction as the predetermined direction, with respect to the 2j^{th} loudspeaker unit.

The driver unit may drive the diaphragm toward the rear side when the input electrical signal has a predetermined polarity. The driver unit of a k^{th} loudspeaker unit (k is a natural number of 2 or 2n, or between them.) of the loudspeaker units may input an electrical signal opposite in phase to the electrical signal input by the driver unit of (k−1)^{th} one of the loudspeaker units. This may make each of volumes of the first and second spaces always constant.

Also, the loudspeaker device may include two loudspeaker units and a space defining section. Each of the loudspeaker units may be generally conical in shape as a whole, and may have a diaphragm, a driver unit disposed on a rear side of the diaphragm for inputting an electrical signal to drive the diaphragm, and a frame body supporting the diaphragm and the driver unit. A second loudspeaker unit of the loudspeaker units may be disposed so as to face a substantially opposite direction with respect to a first one of the loudspeaker units. The frame body thereof may be adjacent to the frame body of the first loudspeaker unit. The space defining section may make a space surrounded by the diaphragm and the frame body of the first loudspeaker unit and a space surrounded by the diaphragm and the frame body of the second loudspeaker unit communicating and being sealed, to define a first space.

The driver unit may drive the diaphragm toward the rear side when the input electrical signal has a predetermined polarity. The driver unit of the second loudspeaker unit may input an electrical signal opposite in phase to the electrical signal that the driver unit of the first loudspeaker unit inputs. This may make a volume of the first space always constant.

### Advantageous Effects of the Invention

Disposing the loudspeaker unit in this manner enables to further shorten the distance between the diaphragms, and thereby to further reduce the volume of the sealed first and second spaces. Thereby, the amount of air moving in the first and second spaces caused by the movement of the diaphragms is further reduced. Thus, the back pressure can be cancelled efficiently, and the minimum resonance frequency of the loudspeaker device can be made smaller.

### BRIEF DESCRIPTION OF DRAWINGS

FIG. 1 shows a side view illustrating an exemplary loudspeaker device 10;

FIG. 2 shows a front view illustrating an exemplary loudspeaker unit 12a;

FIG. 3 shows a side view illustrating the loudspeaker unit 12a;

FIG. 4 shows a rear view illustrating the loudspeaker unit 12a;

FIG. 5 shows a front view illustrating an exemplary first space defining section 13a;

FIG. 6 shows a side view illustrating the first space defining section 13a;

FIG. 7 shows a cross-sectional view along VII-VII illustrating the first space defining section 13a;

FIG. 8 shows a front view illustrating an exemplary second space defining section 14a;

FIG. 9 shows a side view illustrating the second space defining section 14a;

FIG. 10 shows a cross-sectional view along X-X illustrating the second space defining section 14a; and

FIG. 11 shows a side view illustrating an exemplary loudspeaker device 10A.

### DESCRIPTION OF EMBODIMENT

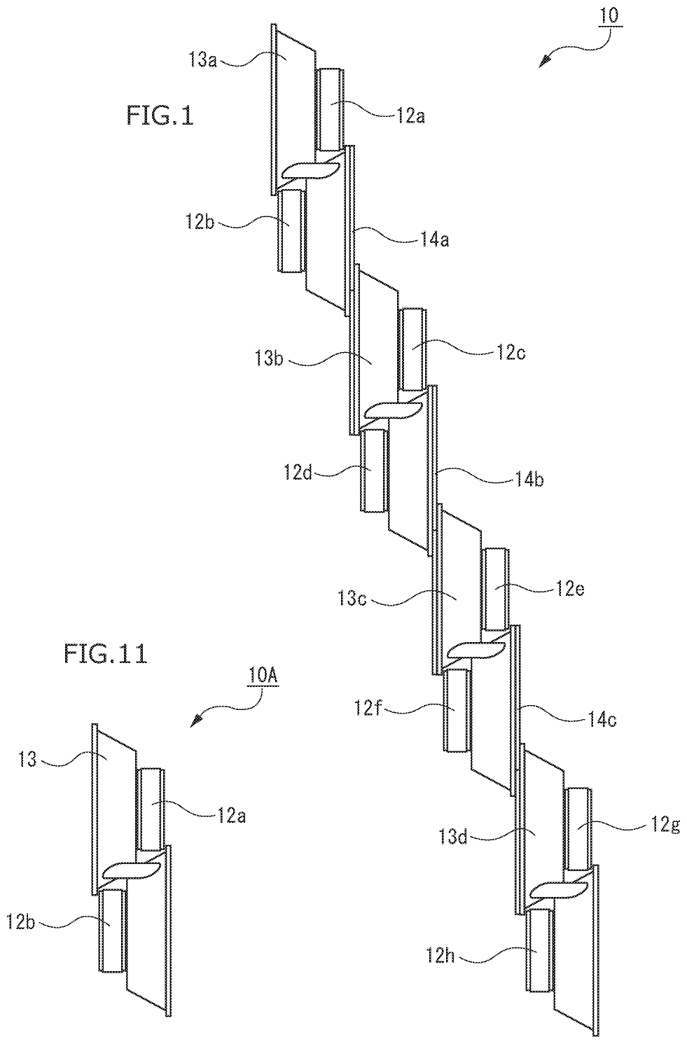

As shown in FIG. 1, a loudspeaker device 10 has the followings.
<Loudspeaker units 12a to 12h> The number of the loudspeaker units is four or a larger even number, e.g., eight.

<First space defining sections 13a to 13d> The number of the first space defining sections is half of the loudspeaker unit, e.g., four.

<Second space defining sections 14a to 14c> The number of the second space defining sections is one less than the number of the first space defining sections, e.g., three.

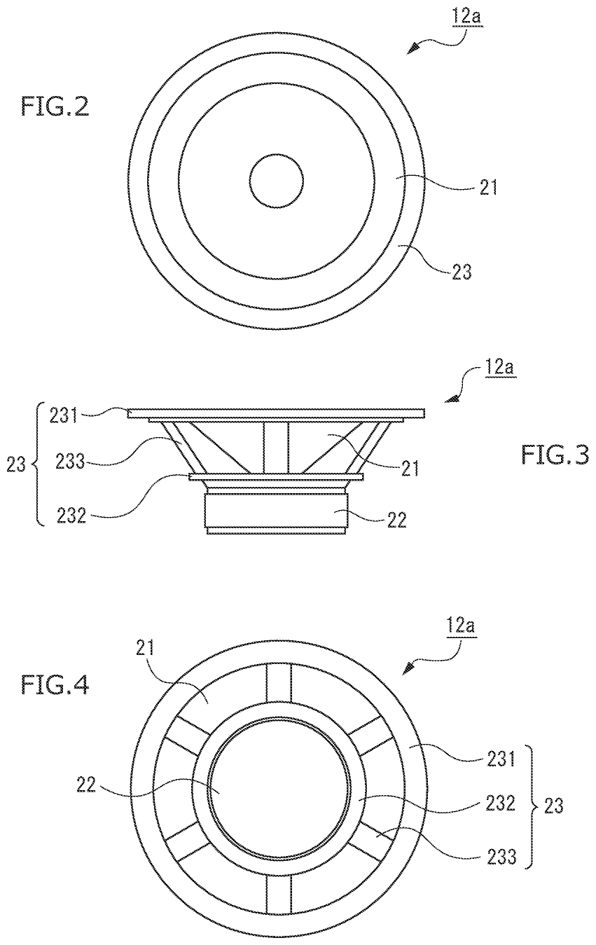

As shown in FIGS. 2 to 4, the loudspeaker unit 12a has the followings.

<A diaphragm 21> It is configured to vibrate to make air vibrate and thereby to generate sound.

<A driver unit 22> It is disposed on the rear side of the diaphragm 21, and configured to input an electrical signal to drive the diaphragm 21. It is, for example, generally circular column-like in shape.

<A frame body 23> It supports the diaphragm 21 and the driver unit 22. It has, for example, two annular ring portions 231 and 232, and six connecting portions 233. The annular ring portion 231 supports the periphery of the diaphragm 21. The annular ring portion 232 is smaller than the annular ring portion 231, and fixed to the driver unit 22. The connecting portion 233 connects the annular ring portion 231 and the annular ring portion 232.

The loudspeaker unit 12a is generally conical in shape as a whole, e.g., approximately circular conical frustum-like. Other loudspeaker units 12b to 12h are also the same as the loudspeaker unit 12a.

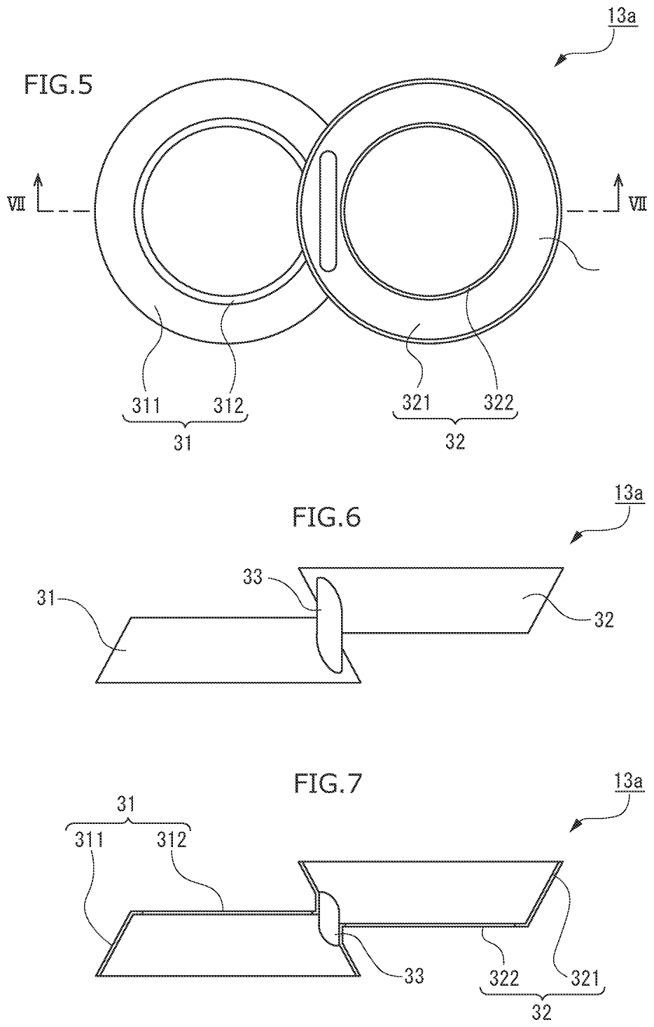

As shown in FIGS. 5 to 7, the first space defining section 13a has the followings.

<Two covering portions 31 and 32> It has a shape fitted to the frame body 23 of the loudspeaker unit. It has, for example, side portions 311 and 321, and annular ring portions 312 and 322. Each of the side portions 311 and 321 has, for example, a shape of a side face of a circular conical frustum. It has one end linked to the annular ring portion 312 or 322, and another end, which is open. The height thereof is approximately equal to the distance between the annular ring portion 231 and the annular ring portion 232. The open end has a diameter smaller than the outer diameter of the annular ring portion 231 and larger than the inner diameter of the annular ring portion 231. Each of the annular ring portions 312 and 322 has an outer diameter larger than the outer diameter of the annular ring portion 232, and an inner diameter smaller than the outer diameter of the annular ring portion 232 and larger than the diameter of the driver unit 22.

<A pipe portion 33> It connects the covering portion 31 and the covering portion 32. It makes a space covered by the covering portion 31 communicating with a space covered by the covering portion 32.

Other first space defining sections 13b to 13d are also the same as the first space defining section 13a.

When the loudspeaker unit is fitted to the covering portion 31 and 32, the driver unit 22 can pass through the annular ring portion 312 and 322, but can not pass through the annular ring portion 232. When the annular ring portion 232 is in contact with the annular ring portion 312 or 322, the annular ring portion 231 is in contact with the open end of the side portion 311 or 321. In this state, an adhesive or other is used to fix the annular ring portion 232 to the annular ring portion 312 or 322 and to fix the annular ring portion 231 to the side portion 311 or 321, and to seal gaps between them. This realizes to form spaces covered with the covering portions 31 or 32 on the rear side of the diaphragm 21. The two spaces are communicated via the pipe portion 33, to form one sealed space, i.e., a first space.

In this manner, two of the loudspeaker units are connected by the first space defining section. The two loudspeaker units connected by the first space defining section are disposed so as to face generally opposite directions, and so that their frame bodies 23 are adjacent to one another.

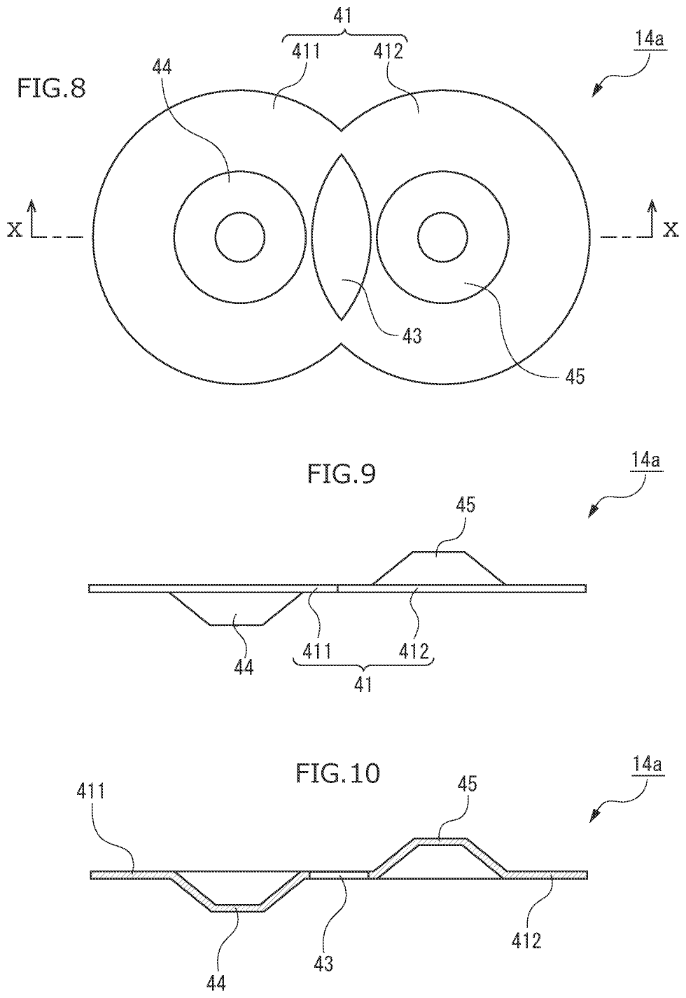

As shown in FIGS. 8 to 10, the second space defining section 14a has the followings.

<A flat plate portion 41> It is a plate having a generally “8” shape, and has two circular disc portions 411 and 412, which are partially overlapped. Each of the circular disc portions 411 and 412 has an outer diameter larger than the inner diameter of the annular ring portion 231 and approximately equal to the outer diameter of the annular ring portion 231. A portion where the two circular disc portions 411 and 412 are overlapped has an opening 43 through it.

<Recesses 44 and 45> Each of Them is located at the center of the circular disc portion 41 or 42, and has a shape along the shape of the diaphragm 21, e.g., a shape of a generally circular conical frustum.

The circular disc portions 411 and 412 are aligned with the annular ring portions 231 of the frame bodies 23 of the loudspeaker units so that the recess 44 and 45 is inward. An adhesive or other is used to fix them and to seal gaps between them. This realizes to form spaces covered with the circular disc portions 411 and 412 on the front sides of the diaphragms 21. The two spaces are communicated via the opening 43, to form one sealed space, i.e., a second space.

In this manner, two of the loudspeaker units are connected by the second space defining section. The two loudspeaker units connected by the second space defining section are disposed generally facing opposite directions and at least portions of the diaphragms 21 closely oppose to one another.

It should be noted that the recesses 44 and 45 do not touch the diaphragms 21. Therefore, the recesses 44 and 45 make the second space narrow without interfering with vibration of the diaphragms 21.

In this manner, the adjacent loudspeaker units are connected by the first space defining section and the second space defining section, to form the loudspeaker device 10 shown in FIG. 1.

The diaphragms 21 of the two loudspeaker units 12a and 12h located at both ends expose their front side to the outside, but do not expose their rear side. The diaphragms 21 of the other loudspeaker units 12b to 12g do not expose their front side or their rear side to the outside.

The adjacent loudspeaker units, connected by the first space defining section or the second space defining section, generally face opposite directions to one another.

Preferably, the even-numbered loudspeaker units 12b, 12d, 12f and 12h are disposed in generally identical directions with respect to the loudspeaker unit 12a, 12c, 12e and 12g connected with them by the first space defining sections 13a to 13d, respectively, and the odd-numbered loudspeaker unit 12c, 12e and 12g are disposed at a position shifted to generally the same directions as the identical directions with respect to the loudspeaker unit 12b, 12d and 12f connected with them by the second space defining sections 14a to 14c, respectively. This realizes significant separation of the two loudspeaker units 12a and 12h disposed at the both ends, and thereby enables to prevent interference of sound generated by the diaphragm 21 of the loudspeaker unit 12a with sound generated by the diaphragm 21 of the loudspeaker unit 12h.

Wiring is made so that the driver units 22 of the odd-numbered loudspeaker units 12a, 12c, 12e and 12g input identical electrical signals and that the driver units 22 of the even-numbered loudspeaker units 12b, 12d, 12f and 12h input identical but opposite-phased electrical signals to them. This realizes all of the diaphragms 21 to move identically. Thereby, each of the volumes of the first and second spaces is always constant. This makes back pressure of the diaphragm 21 cancelled, and thereby makes the minimum resonance frequency of the loudspeaker device small.

The loudspeaker units 12a to 12h are optimally disposed to make the volumes of the first and second spaces as small as possible. This enables to quickly eliminate unevenness of the pressure generated in the first and second spaces caused by the movement of the diaphragm 21, and thereby to efficiently cancel the back pressure of the diaphragm 21. This makes the minimum resonance frequency of the loudspeaker device further small.

As shown in FIG. 11, the loudspeaker device 10A has two loudspeaker units 12a and 12b, and a space defining section 13. The loudspeaker units 12a and 12b are the same as the loudspeaker unit described above. Also, the space defining section 13 is the same as the first space defining section 13a described above.

The loudspeaker device 10A is a simplified version of the loudspeaker device 10. The number of the loudspeaker units is two. This enables to reduce the size of the entire loudspeaker device 10A.

Embodiments described above are examples for facilitating understanding of the present invention. The present invention is not limited thereto and includes those that have been variously modified, altered, added, or removed without departing from the scope defined by the appended claims. This can be easily understood by those skilled in the art from the above description.

The first space defining section may have a configuration different from that described above. For example, the first space defining section may be constituted by a plurality of filling portions that fill the gap between the connecting portions 233 of the frame body 23, instead of the covering portion configured integrally. This enables to further reduce the volume of the first space. Also, the first space defining section may be constituted by one or more filling portions that fill the gap between the connecting portions 233 of the two loudspeaker units connected by the first space defining section, instead of the pipe portion.

The second space defining section may have a configuration different from that described above. For example, the two loudspeaker units connected by the second space defining section may be disposed such that the diaphragms oppose face-to-face. In this case, the second space defining section may be constituted by an adhesive or other sealing members for sealing and fixing a gap between the annular ring portions 231 of the two loudspeaker units connected by the second space defining section. The plurality of the loudspeaker units may be aligned on a spiral curve, for example, rather than aligned generally on a straight line. This makes the distance between the two loudspeaker units disposed at both ends short. However, this enables to reduce the overall size thereof, and to increase its strength. Also, it is superior in terms of design.

### REFERENCE SIGNS LIST

10 and 10A: loudspeaker device; 12a to 12h : loudspeaker unit; 21: diaphragm; 22: driver unit; 23: frame body; 231, 232, 312 and 322: annular ring portion; 233: connecting portion; 13: space defining section; 13a to 13d : first space defining section; 31 and 32: covering portion; 311 and 321: side portion; 33: pipe portion; 14a to 14c : second space defining section; 41: flat plate portion; 411 and 412: circular disc portion; 43: opening; and, 44 and 45: recess.

1. A loudspeaker device, comprising:
two loudspeaker units; and
a space defining section,
wherein each of the loudspeaker units is generally conical in shape as a whole, and includes:
a diaphragm;
a driver unit disposed on a rear side of the diaphragm, for inputting an electrical signal to drive the diaphragm; and
a frame body supporting the diaphragm and the driver unit,
wherein a second loudspeaker unit of the loudspeaker units is disposed so as to face a substantially opposite direction with respect to a first one of the loudspeaker units, and so that the frame body thereof is adjacent to the frame body of the first loudspeaker unit, and
wherein the space defining section makes a space surrounded by the diaphragm and the frame body of the first loudspeaker unit and a space surrounded by the diaphragm and the frame body of the second loudspeaker unit communicating and being sealed, to define a first space.

2. The loudspeaker device of claim 1,
wherein the driver unit drives the diaphragm toward the rear side when the input electrical signal has a predetermined polarity, and
wherein the driver unit of the second loudspeaker unit inputs an electrical signal opposite in phase to the electrical signal that the driver unit of the first loudspeaker unit inputs, and thereby, a volume of the first space is always constant.

3. A loudspeaker device, comprising:
a 2n number (n is a natural number of 2 or larger.) of loudspeaker units;
a n number of first space defining sections; and
a (n−1) number of second space defining section,
wherein each of the loudspeaker units is generally conical in shape as a whole, and includes:
a diaphragm;
a driver unit disposed on a rear side of the diaphragm, for inputting an electrical signal to drive the diaphragm; and
a frame body supporting the diaphragm and the driver unit,
wherein a 2i^{th} loudspeaker unit (i is a natural number of n or smaller.) of the loudspeaker units is disposed so as to face a substantially opposite direction with respect to a (2i−1)^{th} one of the loudspeaker units, and so that the frame body thereof is adjacent to the frame body of the (2i−1)^{th} loudspeaker unit,
wherein a i^{th} one of the first space defining sections makes a space surrounded by the diaphragm and the frame body of the (2i−1)^{th} loudspeaker unit and a space surrounded by the diaphragm and the frame body of the 2i^{th} loudspeaker unit communicating and being sealed, to define a first space,
wherein a (2j+1)^{th} loudspeaker unit (j is a natural number of (n−1) or smaller.) of the loudspeaker units is disposed so as to face a substantially opposite direction with respect to a 2j^{th} one of the loudspeaker units, and so that at least a portion of the diaphragm thereof closely opposes at least a portion of the diaphragm of the 2j^{th} loudspeaker unit, and
wherein a j^{th} one of the second space defining section seals a space surrounded by the diaphragm of the 2j^{th} loudspeaker unit and the diaphragm of the (2j+1)^{th} loudspeaker unit, to define a second space.

4. The loudspeaker device of claim 3,
wherein the 2i^{th} loudspeaker unit is disposed in substantially the same direction as a predetermined direction with respect to the (2i−1)^{th} loudspeaker unit,
wherein the (2j+1)^{th} loudspeaker unit is disposed at a position shifted in substantially the same direction as the predetermined direction with respect to the 2j^{th} loudspeaker unit.

5. The loudspeaker device of claim 3,
wherein the driver unit drives the diaphragm toward the rear side when the input electrical signal has a predetermined polarity, and
wherein the driver unit of a k^{th} loudspeaker unit (k is a natural number of 2 or 2n, or therebetween.) of the loudspeaker units inputs an electrical signal opposite in phase to the electrical signal input by the driver unit of a (k−1)^{th} one of the loudspeaker units, and thereby, each of volumes of the first and second spaces is always constant.
